(19) United States
(12) Patent Application Publication
(10) Pub. No.: US 2022/0343440 A1
(43) Pub. Date: Oct. 27, 2022

(54) AGRICULTURE SERVICE PLATFORM

(71) Applicant: Nutrien AG Solutions, Inc., Loveland, CO (US)

(72) Inventors: Greg Zimmers, Broomfield, CO (US); Paul S. Miller, Champaign, IL (US); Richard Penhale, Windsor, CO (US)

(21) Appl. No.: 17/764,667

(22) PCT Filed: Sep. 29, 2020
(86) PCT No.: PCT/US20/53250

§ 371 Date: Mar. 29, 2022

Related U.S. Application Data
(60) Provisional application No. 62/907,989, filed on Sep. 30, 2019.

(51) Int. Cl. G06Q 50/02; G06Q 30/06; G06Q 10/10; G06Q 30/04

(52) U.S. Cl. CPC G06Q 50/02; G06Q 30/0613; G06Q 30/0641; G06Q 10/1097; G06Q 30/04

(57) ABSTRACT

A system, method, and operating environment facilitate providing year-round agriculture management services to a grower. The method may include determining a geographic location of a field associated with a grower; obtaining information representative of an event prediction, such as a weather forecast, corresponding to the geographic location from one or more information sources; obtaining grower data associated with the grower; predicting an agronomic consequence based on the event prediction and the grower data; and providing a notification of the event prediction to the grower.

### CROSS REFERENCE TO RELATED APPLICATION

This application claims priority to Provisional Application No. 62/907,989, filed Sep. 30, 2019, which is herein incorporated by reference in its entirety.

### BACKGROUND

The agriculture market is undergoing significant evolution in conjunction with recent technological innovation. Growers are engaging in “real time” in new ways, and increasingly expect to engage with suppliers online, are purchasing more online, and are increasingly relying on readily-available data to help in making decisions.

### SUMMARY

Embodiments of the subject matter disclosed herein include a digital platform that facilitates providing a simple, contextually-relevant and customized user experience to growers. Embodiments of the platform may facilitate enabling crop consultants to be growers' trusted partners. The platform may be configured, for example, for managing commercial and agronomic farm operations, while providing integrated experiences that are relevant to growers through the year. Embodiments of the platform may provide any number of different capabilities such as E-commerce and account management capabilities that feature ready access to account information, statements, invoices, online payments, order history, product research, and/or the like. Agronomic capabilities may include, for example, easy-to-use interfaces configured to facilitate developing and sharing crop plans, enhanced fertilizer and nutrient advisory tools, and/or the like. Sales planning capabilities may include, for example, the ability to quickly see a grower's history, access to tools to help crop consultants manage their book of business, and/or the like.

Embodiments include a system configured to facilitate agriculture management. The system includes a server device having a processor and a computer-readable memory having computer-executable instructions embodied thereon, where the instructions are configured to cause the processor, upon being executed by the processor, to perform a method of facilitating a consistent user experience for agriculture management. In embodiments, the method includes detecting a trigger event; identifying a corresponding grower; accessing stored grower data associated with the corresponding grower to determine a grower status of the corresponding grower; creating a user interface having a layout that is designed based on the grower status; and providing the user interface to the grower.

Embodiments provide a method of facilitating agriculture management. The method includes detecting a trigger event; identifying a corresponding grower; accessing stored grower data associated with the corresponding grower to determine a grower status of the corresponding grower; creating a user interface having a layout that is designed based on the grower status; and providing the user interface to the grower.

Embodiments provide another method of facilitating agriculture management. In embodiments, the method includes obtaining grower data associated with a grower; associating, in a consultant database, the grower with an identified consultant; receiving a notification regarding a grower deficiency, the grower deficiency including an aspect of a grow operation that could benefit from intervention; determining an interventional product and/or service associated with the grower deficiency; identifying, by accessing the consultant database, the associated consultant; modifying a grower interface experience to include a notification regarding the grower deficiency and the identified interventional product and/or service; and providing the consultant with access to the grower interface experience.

Embodiments provide a method of providing year-round agriculture management services, utilizing a system. The method includes determining a geographic location of a field associated with a grower; obtaining weather information corresponding to the geographic location from one or more information sources; aggregating the weather information to generate aggregated weather data; generating, based on the aggregated weather data, a weather prediction corresponding to the geographic location; obtaining grower data associated with the grower; predicting an agronomic consequence based on the weather prediction and the grower data; creating a mitigation package based on the predicted agronomic consequence; and providing a notification of the mitigation package and optionally the weather prediction and/or agronomic consequence to the grower. In embodiments, creating the mitigation package comprises determining an amount of a nutrient product to be added to the at least one field associated with the grower. In embodiments, the notification comprises a selectable representation configured to cause the system to provide an order interface in response to user selection of the selectable representation, wherein the order interface facilitates at least one of ordering the nutrient product and scheduling its application.

Yet other embodiments provide a method of providing agriculture management services utilizing a system. The method includes determining a geographic location of a field associated with a grower; obtaining weather information corresponding to the geographic location from one or more information sources (e.g., current weather, a weather forecast); obtaining grower data associated with the grower (e.g., from a database); predicting an agronomic consequence based on the weather information and the grower data; creating a mitigation package based on the predicted agronomic consequence; and providing a notification of the mitigation package and optionally the weather prediction and/or agronomic consequence to the grower. In embodiments, the grower information can include agronomic information. Examples of the agronomic information include field information such as soil type, drainage characteristics, historical soil temperature and moisture levels, historical levels, patterns and other data for weather-related information such as radiation, rainfall, wind temperature and humidity, and historical levels, patterns and other data regarding inputs such as nutrients, fertilizers, pesticides and herbicides, irrigation practices and related amounts and history, planting dates. Yet additional examples of the agronomic information include crop information such as the types of crops currently and/or historically grown on the field, and the types of seed. Still additional examples of crop information include seed-specific information such as germination time frames and characteristics, optimum times for inputs (e.g., nutrient) applications, disease, insect and weed susceptibilities. In yet other embodiments, imagery information can be obtained and used in addition or as an alternative to weather information, or as information for predicting an agronomic consequence.

In embodiments, weather is a forcing function for agronomics. Agronomic predictions are generated based on one or more factors such as geographic location, grower agricultural management and/or modeling of the agricultural system based on current weather and/or weather forecasts. Information used to generate the predictions can be derived from databases (e.g., third party weather forecasts, and grower, field and crop agronomics), on-site observations (e.g., obtained by crop consultants) and/or crowd sourced (e.g., from sources describing conditions at neighboring or other geographically relevant field locations).

Embodiments provide another method, which includes determining that a grower's field should be sampled for nutrient levels; notifying a consultant associated with the grower of the determination; defining a field boundary corresponding to the grower's field; defining, based on the field boundary, a sampling grid; and receiving sample data, the sample data including a plurality of data points, each data point including a sample location and at least one soil characteristic associated with the sample location. Embodiments of the method further include associating, based on the sample location, the sample data with the sample grid; generating a post sample package; and notifying the grower and the consultant of the post sample package. The post sample package may include a request for an order of a nutrient product. The method further includes receiving an order, corresponding to the post sample package, from the grower; scheduling an application of the nutrient package; notifying the grower and consultant of the application scheduling, the start of the application of the nutrient product, and the completion of the application of the nutrient product; and generating and providing an invoice to the grower corresponding to the application of the nutrient product.

Embodiments include another method of providing agriculture management services, utilizing a system. The method may include determining a geographic location of a field associated with a grower; obtaining information corresponding to the geographic location from one or more information sources; generating, based on information, an event prediction corresponding to the geographic location; obtaining grower data associated with the grower; predicting an event consequence based on the event prediction and the grower data; and providing a notification of the event prediction to the grower.

Embodiments also include a method of providing agriculture management services utilizing a system. The method may include determining a geographic location of a field associated with a grower, obtaining information representative of an event prediction corresponding to the geographic location, obtaining grower data associated with the grower, predicting an agronomic consequence based on the event prediction and the grower data, and providing a notification of the agronomic consequence to the grower. In embodiments, obtaining information representative of an event prediction includes obtaining information representative of a weather forecast, a disease forecast, or a pest forecast. In embodiments, the grower data comprises at least one of a type of crop planted in at least one field associated with the grower, and a characteristic of soil of at least one field associated with the grower. Embodiments of the method may further comprise creating a mitigation package based on the predicted agronomic consequence, wherein creating the mitigation package comprises determining an amount of a nutrient to be added to the at least one field associated with the grower. The notification may comprise a selectable representation configured to cause the system to provide an order interface in response to user selection of the selectable representation, wherein the order interface facilitates at least one of ordering the nutrient and scheduling its application.

While multiple embodiments are disclosed, still other embodiments of the present disclosure will become apparent to those skilled in the art from the following detailed description, which shows and describes illustrative embodiments of the disclosure. Accordingly, the drawings and detailed description are to be regarded as illustrative in nature and not restrictive.

### BRIEF DESCRIPTION OF THE DRAWINGS

FIG. 1 is a block diagram depicting an illustrative system for facilitating providing an integrated digital platform configured to facilitate providing agriculture products and/or agriculture support services to users, in accordance with embodiments of the disclosure.

FIG. 2 is a block diagram depicting an illustrative computing device, in accordance with embodiments of the subject matter disclosed herein.

FIG. 3 is a block diagram depicting an illustrative operating environment, in accordance with embodiments of the subject matter disclosed herein.

FIG. 4 is a flow diagram depicting a method of facilitating agriculture management by providing an experience to a grower, in accordance with embodiments of the subject matter disclosed herein.

FIG. 5 is a flow diagram depicting an illustrative method of providing year-round agriculture management services, in accordance with embodiments of the subject matter disclosed herein.

FIG. 6 is a flow diagram depicting another illustrative method of providing year-round agriculture management services, in accordance with embodiments of the subject matter disclosed herein.

FIG. 7 is a flow diagram depicting another illustrative method of providing year-round agriculture management services, in accordance with embodiments of the subject matter disclosed herein.

While the disclosed subject matter is amenable to various modifications and alternative forms, specific embodiments have been shown by way of example in the drawings and are described in detail below. The intention, however, is not to limit the disclosure to the particular embodiments described. On the contrary, the disclosure is intended to cover all modifications, equivalents, and alternatives falling within the scope of the disclosure as defined by the appended claims.

### DETAILED DESCRIPTION

Embodiments of the subject matter disclosed herein include a platform of tools for providing an interactive, contextually-relevant, and customized agriculture support experience. In embodiments, an integrated digital platform is provided that is designed to empower growers to effectively manage their agronomic and commercial needs. Embodiments of the platform provide growers with an easy to use, centralized digital service hub, enabling customers to interact with agronomists and field service representatives seamlessly.

For example, traditionally, agriculture support platforms required a user to navigate through a set of menus, screens, and/or the like, before finally arriving at a useful set of content. Embodiments of the subject matter disclosed herein may utilize, for example, a number of APIs to provide access to a diverse set of tools, data, and predictive services, thereby providing a more useful user experience upon logging in. That is, for example, embodiments of the platform described herein are configured to collect information and utilize that information to be able to facilitate providing a recommendation to a user immediately when the user logs in and/or to push a notification of the recommendation via other communication channels such as, for example, email, text, and/or the like. The user may then provide further information and/or engage in further interactions, resulting in enhancements to the recommendation.

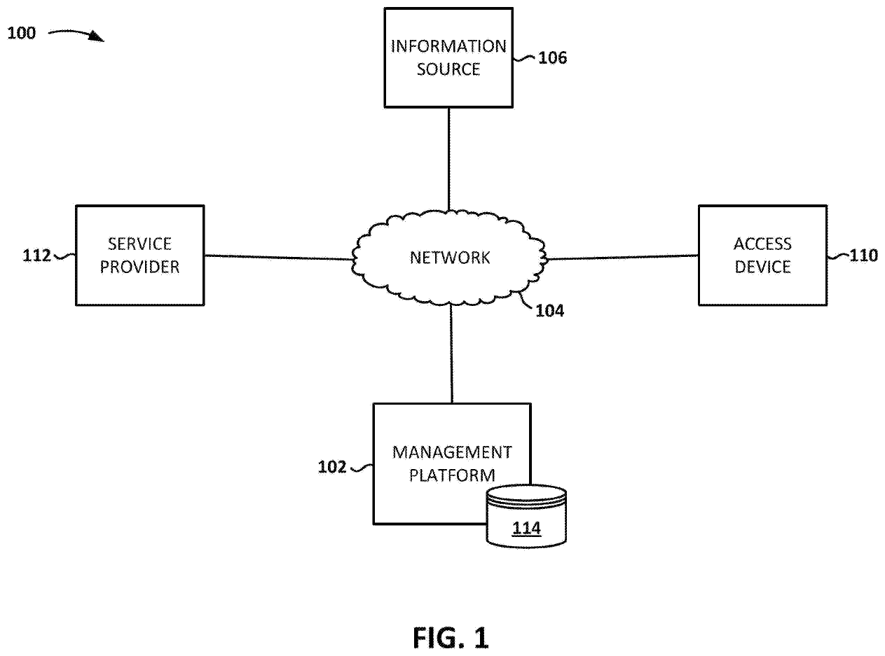

FIG. 1 is a block diagram depicting an illustrative system 100 to facilitate providing agriculture products and/or agriculture support services to users, in accordance with embodiments of the disclosure. According to embodiments, agriculture products may include fertilizer, pesticide, seeds, equipment, and/or the like, and agriculture support services may include, for example, agronomic services (e.g., crop planning services), information services (e.g., weather information services, pest alert services, analytic services, and/or the like.

A user, as used throughout this document, refers to a customer, consultant (e.g., an employee), supplier, distributer, and/or any other person or entity capable of consuming and/or otherwise taking advantage of one or more services and/or other aspects of embodiments of the subject matter disclosed herein. In embodiments, for example, the system 100 may include an ecommerce service through which a user may purchase agriculture goods, a crop planning service through which agronomics may be used to facilitate assisting a customer (e.g., a grower) with planning one or more grow operations on a farm, and/or the like. In embodiments, aspects of the system 100 may be configured to provide one or more recommendations regarding agriculture products and/or processes to apply to a particular grow operation at a particular time, in a particular manner, and/or the like.

As shown in FIG. 1, the illustrative system 100 includes a management platform 102 that accesses information, via a network 104, from an information source 106. The network 104 may be, or include, any number of different types of communication networks such as, for example, a short messaging service (SMS), a local area network (LAN), a wireless LAN (WLAN), a virtual LAN (VLAN), a wide area network (WAN), the Internet, a peer-to-peer (P2P) network, custom-designed communication or messaging protocols, and/or the like. The network 104 may include a combination of multiple networks. The information source 106 may include, for example, the Internet, an email provider, a website, a social media platform, a user profile database, a market information source, a user interface, a weather service, a satellite imaging service, an imaging device (e.g., a drone with a camera, an infrared imaging device, etc.), and/or the like. In embodiments, the information source 106 may include a large number of different information sources.

According to embodiments, the management platform 102 uses the accessed information to generate, update, analyze, and customize an experience for a user that is provided to a user via an access device 110. In embodiments, for example, the user may be a customer (e.g., a grower), a consultant (e.g., an employee such as a customer service representative of the entity that maintains the management platform 102), a supplier, and/or the like. The access device 110 may be any type of computing device such as, for example, a laptop computer, a desktop computer, a computer workstation, a mobile device (e.g., a smartphone), and/or the like. The management platform 102 may use the accessed information to generate any number of different recommendations regarding actions to take regarding a grow operation, products to apply to a field, and/or the like. In embodiments, management platform 102 may obtain information from the information source 106 that can be used to customize the user's experience with the management platform. According to embodiments, the information source 106 may be, or include, the access device 110.

The management platform 102 may be configured to facilitate any number of agriculture support services such as, for example, by providing access to recommendations, products, services and/or related information, and/or by utilizing a service provider 112. The management platform 102, the information source 106, and/or the service provider 112 may be implemented using one or more servers, which may be, include, or may be included in, a computing device that includes one or more processors and a memory. The one or more servers, and/or any one or more components thereof, may be implemented in a single server instance, multiple server instances (e.g., as a server cluster), distributed across multiple computing devices, instantiated within multiple virtual machines, implemented using virtualized components such as virtualized processors and memory, and/or the like.

The management platform 102 obtains, copies, or otherwise accesses user and/or market data from the information source 106. Although depicted as a single component solely for the purposes of clarity of description, the information source 106 may actually refer to more than one information source 106. The management platform 102 may store the data, portions of the data, and/or information extracted from the data in a database 114. The database 114, which may refer to one or more databases, may be, or include, one or more tables, one or more relational databases, one or more multi-dimensional data cubes, and the like. Further, though illustrated as a single component, the database 114 may, in fact, be a plurality of databases 114 such as, for instance, a database cluster, which may be implemented on a single computing device or distributed between a number of computing devices, memory components, or the like. Data used by the management platform 102 can also be crowd sourced.

In operation, the management platform 102 accesses user information (e.g., from the database 114, the information source 106, and/or the like) and, based on the data, provides a customized user experience via a user interface implemented by the access device 110. According to embodiments, the management platform 102 may be configured, for example, to provide an initial user interface screen that includes content customized to a particular user based on user information and/or other information (e.g., weather data, predictive data, market data, soil data, etc.). User information and/or other information may include contemporary data, historical data, predicted data, and/or the like.

In this manner, for example, embodiments of the user experience system 108 may be configured to cause a contextually-relevant user interface to be presented to a customer that includes content associated with the customer's current grow operations such as, for example, current market information associated with a crop that the customer is growing, a product recommendation (e.g., a recommendation of a certain product to apply to a crop that the customer is growing), operations recommendations (e.g., a recommendation that, based on a certain weather pattern or event (including “non-events” such as drought or other low precipitation periods), the customer should perform some operation with respect to a crop that the customer is growing), combinations of recommendations, information associated with information that the customer has previously requested, information associated with regulatory developments that may pertain to a customer's current grow operations, and/or the like.

According to embodiments, the management platform 102 may be configured to cause a contextually-relevant user interface to be presented, via an access device 110, to a consultant. A consultant may refer to any employee or agent of an entity associated with the management platform 102 such as, for example, a crop consultant employed by the entity that hosts the management platform 102 and who interacts with customers to assist them with crop planning, product selection, and/or the like. In embodiments, for example, the user experience system 108 may be configured to provide a user interface to a consultant that includes user information associated with a customer with whom the consultant is associated (e.g., a customer to whom the consultant is assigned), company information associated with the consultant's employer, reminders associated with customers and/or orders, and/or the like. In embodiments, the management platform 102 may be configured to provide a user interface that is similar, or identical to, a user interface that is provided to a customer with whom the consultant is associated.

In the context of this disclosure, user information (which may be referred to, interchangeably, as grower information and/or grower data) refers to any type of information that may be associated with a user such as, for example, user demographic data, operations data associated with a user's agriculture operations, user activity data associated with a user's activities, user account data, agronomic information associated with the user and the user's organization, fields and crops, and/or the like. For example, in embodiments, user demographic data may include a user's name, age, address, occupation, place of business, social security number, gender, and/or the like. Operations data associated with a user's agriculture operations may include any number of different types of data about a user's agriculture operations, and may include information at the organization level, farm level, the field level, and/or the crop level.

For example, organization level information may include information associated with operations of a grower across a number of different farms, which may be located at different geographic locations. For example, organization level information may include a region within which farms are located, aggregated farm level information (e.g., aggregated yield across multiple farms, aggregated input information, etc.), financial information across more than one farm, logistical information, and/or the like. Farm level information for each farm in an organization may include a location (e.g., by address, by county, by longitude and latitude, etc.) of a user's farm, utilization metrics (e.g., the number and/or percentage of acres and/or square yards of the farm utilized during a particular season, average utilization data, etc.), a farm's altitude (e.g., average altitude, range of altitudes, particular altitudes at certain locations, etc.), and/or the like. Field level information for each field in a farm may include, for example, a field's location (e.g., by address, by county, by longitude and latitude, etc.), soil types, soil compositions, utilization metrics associated with a field, a field's altitude, a type of crop (or types of crops) planted in the field at a given time, a crop rotation schedule for a field, and/or the like. Crop level data may include, for example, historical crop plans, a type of crop planted by the user (e.g., corn, wheat, barley, soy beans); a variety of the crop (e.g., sweetcorn, popcorn, dent corn, etc.); the variety of the seed; a planting date for a crop; input information associated with inputs such as, for example, product application dates (e.g., dates on which certain types of agricultural products were applied to the crop), product application identifiers (e.g., identifications of the types of products applied to the crop), product application rates and/or amounts, and a predicted harvest date for a crop; yields produced; historical weather information such as levels and patterns of radiation and rain; and/or the like. Agronomic information can include information at a seed variety-specific level, a field-specific level, and a farm-specific level, for example.

User activity data may include, for example, data associated with a user's interaction with an application, mobile application, web portal, and/or the like, such as, for example, a number of times a user accesses a user experience application, dates on which the user accesses the user experience application, the activities the user performs with respect to the user experience application, purchase information associated with the user prior purchases, inferential data associated with the user (e.g., data determined based on user behavior data using one or more algorithms such as, for example, machine learning algorithms), and/or the like. User account data may include, for example, any number of different types of information associated with a user account maintained by the management platform and may include, for example, an account identifier, an account type, account access restrictions, account settings, user preferences, and/or the like.

In embodiments, the management platform 102 may include and/or work with any number of systems, applications, program components, and/or the like, to facilitate providing a user experience. For example, in embodiments, the management platform 102 may include any number of programming components such as, for example, applications, application components, application programming interfaces (APIs), databases, dynamic libraries, and/or the like. The management platform 102 may include any number of other components or combination of components including, for example, a security component, a user authorization component, a registration component, a software provisioning component, and/or the like.

According to embodiments, the management platform 102 may be configured to perform any number of different kinds of analysis on the data received from the information source 106 and may be configured to provide results of that analysis to the access device. The results of the analysis may include any number of different types of information such as, for example, crop planning information, agronomic information, recommendations, notifications, and/or the like.

The management platform 102 may be configured to support any number of different agronomic services including, for example, a crop planning service. Embodiments of the management platform 102 may be configured to facilitate comprehensive approach to agronomic planning that allows customers to benefit from historical field and product performance, and share data electronically with farm consultants to ensure everyone is working with a common set of information and toward the same objectives. According to embodiments, the management platform 102 may facilitate developing a customer (or assisting a customer to develop) a crop plan, managing a crop plan, and/or the like. In embodiments, the management platform 102 may facilitate budget planning, provide scenario comparisons, facilitate interactions between customers and crop consultants, provide nutrient management services and/or recommendations, provide pest alerts, and/or the like.

According to embodiments, the management platform 102 may be configured to facilitate providing products and/or services to customers. For example, in embodiments, the management platform 102 may be configured to provide a product shopping environment to a user, through which a user may browse, select, and purchase agriculture products such as inputs (e.g., fertilizers, pesticides, etc.), seeds, equipment, and/or the like. In embodiments, the management platform 102 may be configured to facilitate connecting customers to service providers such as, for example, equipment mechanics, labor forces, and/or the like.

In embodiments, the management platform 102 may use user information and/or other information to facilitate providing one or more services. Aspects of the services may be provided using the management platform 102 and/or the service provider 112 which may include, for example, applications, service functions, third-party integrators, and/or the like, that provide services and/or information for facilitating providing agriculture products and services. In embodiments, the service provider 112 may refer to one or more service providers 112, any one or more of which (and/or components thereof) may be integrated with the management platform 102, managed by the same and/or a different entity as that managing the management platform 102, and/or the like. In embodiments, the service provider 112 may refer to a provider of weather information services, input (e.g., fertilizer) prescription services, market prediction services, sources of agronomic information (e.g., seed variety-specific information from seed vendors), and/or the like, and which may be a separate entity than the entity that provides/manages the management platform 102.

The illustrative agriculture support system 100 shown in FIG. 1 is not intended to suggest any limitation as to the scope of use or functionality of embodiments of the present disclosure. The illustrative system 100 also should not be interpreted as having any dependency or requirement related to any single component or combination of components illustrated therein. Additionally, various components depicted in FIG. 1 may be, in embodiments, integrated with various ones of the other components depicted therein (and/or components not illustrated), all of which are considered to be within the ambit of the present disclosure.

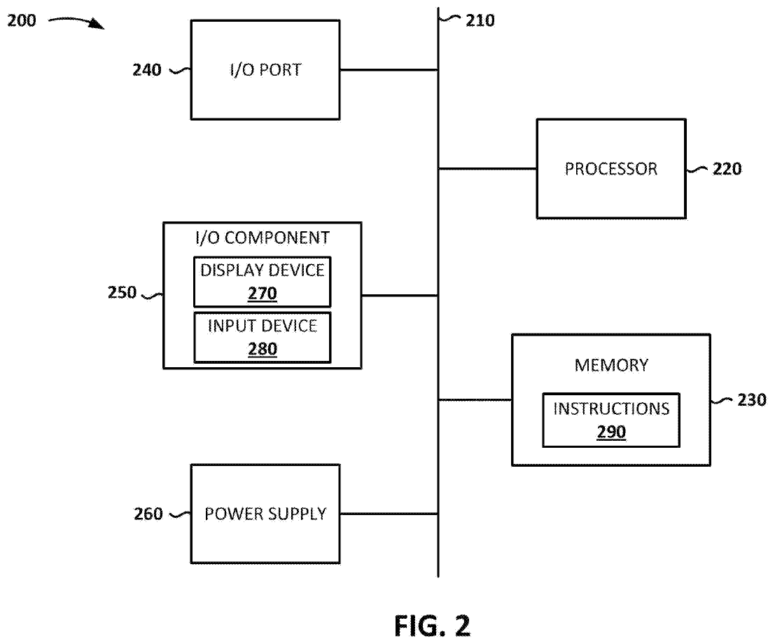

According to various embodiments of the disclosed subject matter, any number of the components depicted in FIG. 1 (e.g., the management platform 102, the information source 106, the access device 110, and/or the service provider 112) may be implemented on one or more computing devices. FIG. 2 is a block diagram depicting an illustrative computing device 200, in accordance with embodiments of the disclosure. The computing device 200 may include any type of computing device suitable for implementing aspects of embodiments of the disclosed subject matter. Examples of computing devices include specialized computing devices or general-purpose computing devices such “workstations,” “servers,” “laptops,” “desktops,” “tablet computers,” “hand-held devices,” “general-purpose graphics processing units (GPGPUs),” and the like, all of which are contemplated within the scope of FIGS. 1 and 2, with reference to various components of the system 100 and/or computing device 200.

In embodiments, the computing device 200 includes a bus 210 that, directly and/or indirectly, couples the following devices: a processor 220, a memory 230, an input/output (I/O) port 240, an I/O component 250, and a power supply 260. Any number of additional components, different components, and/or combinations of components may also be included in the computing device 200. The I/O component 250 may include a presentation component configured to present information to a user such as, for example, a display device 270, a speaker, a printing device, and/or the like, and/or an input device 280 such as, for example, a microphone, a joystick, a satellite dish, a scanner, a printer, a wireless device, a keyboard, a pen, a voice input device, a touch input device, a touch-screen device, an interactive display device, a mouse, and/or the like.

The bus 210 represents what may be one or more busses (such as, for example, an address bus, data bus, or combination thereof). Similarly, in embodiments, the computing device 200 may include a number of processors 220, a number of memory components 230, a number of I/O ports 240, a number of I/O components 250, and/or a number of power supplies 260. Additionally, any number of these components, or combinations thereof, may be distributed and/or duplicated across a number of computing devices.

In embodiments, the memory 230 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; and/or any other medium that can be used to store information and can be accessed by a computing device such as, for example, quantum state memory, and/or the like. In embodiments, the memory 230 stores computer-executable instructions 290 for causing the processor 220 to implement aspects of embodiments of system components discussed herein and/or to perform aspects of embodiments of methods and procedures discussed herein.

The computer-executable instructions 290 may include, for example, computer code, machine-useable instructions, and the like such as, for example, program components capable of being executed by one or more processors 220 associated with the computing device 200. Program components may be programmed using any number of different programming environments, including various languages, development kits, frameworks, and/or the like. Some or all of the functionality contemplated herein may also, or alternatively, be implemented in hardware and/or firmware.

The illustrative computing device 200 shown in FIG. 2 is not intended to suggest any limitation as to the scope of use or functionality of embodiments of the present disclosure. The illustrative computing device 200 also should not be interpreted as having any dependency or requirement related to any single component or combination of components illustrated therein. Additionally, various components depicted in FIG. 2 may be, in embodiments, integrated with various ones of the other components depicted therein (and/or components not illustrated), all of which are considered to be within the ambit of the present disclosure.

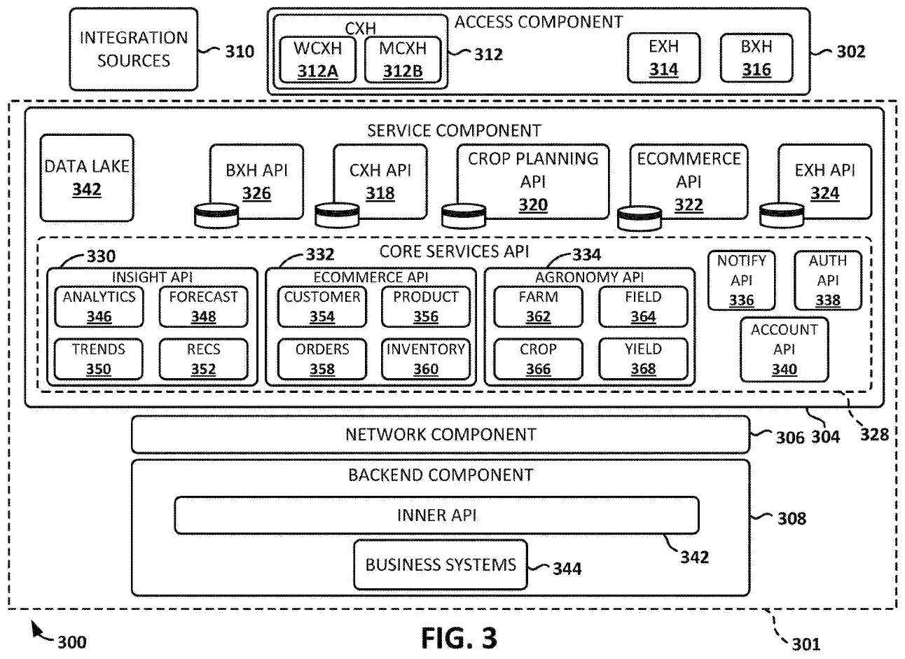

FIG. 3 is another block diagram depicting an illustrative operating environment 300, in accordance with embodiments of the disclosure. According to embodiments, the operating environment 300 may be similar to, include, or be included in the system 100 depicted in FIG. 1. As shown in FIG. 3, the operating environment 300 may include a management platform 301 and an access component 302. According to embodiments, the management platform 301 may be similar to, include, or be included in the management platform 102 depicted in FIG. 1. As shown in FIG. 3, the management platform 301 may include a service component 304, a network component 306, and a backend component 308. The operating environment 300 may also include integration sources 310. In embodiments, the access component 302 may be implemented by one or more access devices (e.g., the access device 110 depicted in FIG. 1) and the integration sources 310 may be implemented by one or more service providers (e.g., the service provider 112 depicted in FIG. 1).

According to embodiments, the access component 302 may include any number of different applications (e.g., web applications, mobile applications, etc.) that may be configured to be instantiated by an access device (e.g., the access device 110 depicted in FIG. 1) to provide specified capabilities through tailored user experiences. As shown in FIG. 3, for example, the access component 302 may include a customer experience hub (CXH) 312, which may include a web-based customer experience hub (WCXH) 312A, and a mobile customer experience hub (MCXH) 312B. The access component may additionally or alternatively include an employee experience hub (EXH) 314 and a business experience hub (BXH) 316. In embodiments, the CXH 312 may include one or more websites, plug-ins, applications and/or application components configured to serve as a hub for providing contextually-relevant content to customers via one or more user interfaces. The content may include, for example, account information, weather information, market information, product and/or operations recommendations, and/or the like. According to embodiments, content provided by the CXH 312 may be any number of different types of content such as, for example, text, audio, audio/video, video, and/or the like. Embodiments of the CXH 312 may additionally, or alternatively, include tools for crop planning, payment submittal, and/or the like.

According to embodiments, the WCXH 312A may be, include, or be included in, a website accessible by a computing device. The WCXH 312A may be, or include, one or more web pages, hyperlinks, pop-up windows, and/or the like. The WCXH 312A may be hosted by one or more web-hosting entities and using one or more servers, virtual servers, and/or the like. In embodiments, the MCXH 312B may be, include, or be included in, a mobile application configured to be implemented on a mobile device. In this manner, a grower may, for example, be able to access any number of aspects of functionality described herein using a mobile device such as, for example, while the grower is in the field, meeting with potential purchasers, and/or the like.

In embodiments, the MCXH 312B (e.g., as shown in FIG. 3) may be configured to be synchronized with a corresponding CXH 312 such as, for example, a CXH 312 that is implemented as an application running on a computing device such as a desktop, a laptop, and/or the like. In embodiments, the MCXH 312B may be configured to be facilitate providing one or more services such as are described herein without the necessity for an active communication connection. For example, many grow operations are located in areas that lack adequate cellular phone service, and, as such, mobile applications that require a cellular connection to facilitate providing services related to corresponding grow operations may not be useful in these areas. Embodiments of the subject matter disclosed herein may include an MCXH 312B implemented on a mobile device and that is configured to be synchronized with a CXH via communicably coupling the mobile device and the computing device upon which the CXH 312 is implemented. In this manner, for example, the CXH 312 may receive updates from a server and provide those updates to the MCXH 312B, thereby facilitating providing the grower with relatively up-to-date information (e.g., information that is current at least as of the last time that the MCXH 312B was synchronized with the other CHX1 312).

The EXH 314 may include one or more applications configured to serve as a hub for providing information and/or tools to internal employees (e.g., consultants) such as, for example, customer account information, agronomic tools such as crop planning, interfaces configured to allow the employee to interface with customers, and/or the like.

According to embodiments the EXH 314 may enable employees such as crop consultants to view content that is delivered to associated customers, user data about customers, communications from customers, and/or the like. The EXH 314 also may enable the consultant to view inventory of products, pricing information, market information, weather information, and/or the like. In this manner, for example, the EXH 314 may be configured to facilitate a seamless consulting experience between the consultant and the customer by providing the consultant with relevant information before, during, and after customer visits.

The BXH 316 may include a developer portal for external developers to securely and quickly gain access to the tools and information they need to explore, test, and consume APIs. That is, for example, the BXH 316 may be configured as an API marketplace. In this manner, for example, developers associated with agriculture operations may be able to access developer tools necessary to build APIs that interact with the operating environment 300 such as, by interacting with the BXH 316. Such interactions may facilitate, for example, automatic ordering of products when inventory is low, obtaining invoice information, obtaining transaction histories automatically, and/or the like. Any number of other services may be facilitated using the BXH 316.

The service component 304 may include services that facilitate providing the user interfaces provided by one or more aspects of the access component 302. According to embodiments, the service component 304 may be implemented on a server, in a distributed server system, via cloud-based services, and/or the like. For example, in embodiments, the service component 304 (or one or more aspects thereof) may be instantiated on third-party web services such as, for example, Amazon Web Services. As shown, the service component 304 may include experience APIs 318, 320, 322, 324, and 326, and a set 328 of core services APIs 330, 332, 334, 336, 338, and 340. As shown, the service component 304 may also include a data lake 342 which may, in embodiments, be a data clearinghouse configured to accept data from any number of different sources and from which data can be accessed by any number of the different APIs in the service component, and/or aspects of other components of the operating environment 300.

According to embodiments, the experience APIs 318, 320, 322, 324, and 326 may include, for example, backend services corresponding to client applications that provide interfaces between the calling client application (e.g., the CXH 312, the EXH 314, or the BXH 316) and the core services APIs, thereby facilitating access to data specific to the desired user experience. As indicated above, the service component 304 may include a set 328 of core services APIs. The core services APIs 330, 332, 334, 336, 338, and 340 may include general purpose process APIs that may be, for example, composable, canonical, shared among resources, and/or the like. The core service APIs may be configured to function as a scalable, modular service layer, servicing the platform internally, providing an operational interface between the access component 302 and the backend component 308. As shown, the backend component 308 includes an inner API 344, which may be configured to provide an interface between the core service APIs and backend business systems 345. Backend business systems 345 may include any number of different types of business systems such as, for example, databases, enterprise resource planning (ERP) systems, transactional systems, user account management systems, accounting systems, inventory systems, scheduling systems, technical support systems, and/or the like. According to embodiments, the backend business systems 345 may be integrated, independent, distributed across a number of platforms, managed by third-parties, and/or the like.

Utilizing a set of core service APIs and an inner API in this manner may facilitate being able to easily scale the system, repair or replace functionality, add functionality, and remove functionality by simply modifying the available program components at the service component level. This arrangement also facilitates seamless modification to the underlying business systems 345 without requiring a rebuilding of the service component 304 and/or access component 302. This offers advantages of efficiency in modifying the system, improving the system, etc., over the typical approach of building the platform up using a more vertical hardware solution.

As shown, the experience APIs may include a CXH API 318 configured to facilitate a contextually-relevant user experience by providing interaction between the CXH 312 and data, analytics, and/or other information used for providing a customized user experience. That is, for example, embodiments of the CXH API 318 may interact with any one or more of the set 328 core services APIs to provide access to data for displaying account information, invoices, statements, purchase history, market information, weather information, product recommendations, operations recommendations, and/or the like, tailored for display in the CXH client 312. In embodiments, the CXH API 318 may be configured to provide endpoints for submitting payments, modifying account information, customizing the user experience, and/or the like.

According to embodiments, for example, the CXH API 318 may be configured to leverage any number of different predictive and analytical capabilities of the operating environment to facilitate providing a dynamic user interface that provides a year-round, anticipatory experience to growers. For example, embodiments include providing notifications related to predicted information at the organization level, farm level, field level, and/or crop level. In embodiments, suggestions may be provided to a grower that may relate to tips for improving grow operations, suggestions for actions to be taken to mitigate impacts on a grow operation from predicted weather events, disease events, and pest events, as well as products and/or services that may be used to facilitate improving a grow operation. For example, embodiments may include generating field maps, pest maps, disease maps, weather maps, agronomic-biomass maps, management zonal maps, crop stress maps, and/or the like, any number of which may be used to predict future adverse situations that may be mitigated, for example, by suggested products (e.g., nutrients, insecticides, fungicides, herbicides, etc.) and/or services. According to embodiments, for example, the CXH API 318 may be configured to work in conjunction with any number of other operating environment components to provide automatic notifications to a grower to indicate recommended dates and/or date ranges for purchasing and/or applying products such as seeds, nutrients, etc., which may be associated with crop plans, as described below.

According to embodiments, the CXH API 318 may be configured to provide access to a grower database and may provide an experience that is enhanced by information maintained in a grower database. According to embodiments, for example, the grower database may include a grower “filing cabinet” available to a grower that includes a well-organized, searchable document repository for any information the grower wishes to save, and may include all information relevant to managing the grower's grow operation (e.g., agronomic reports, financial reports, permits, licenses, invoices, historical yield reports, etc.). The grower database may include grower data that may be organized, for example, at the organization level, farm level, field level, crop level, and/or the like. It may include historical data regarding crops planted in certain fields, historical data regarding inputs applied to the fields (e.g., types of seeds and planting dates, fertilizers and application rates, pesticides and application rates, fungicides and application rates, historical soil conditions, etc.), historical data regarding yields (e.g., imagery-based yield information, actual yield data, harvested amounts by weigh and/or volume, weigh ticket amounts, sales amounts, etc.), historical weather (e.g., radiation, precipitation, temperatures). Other items of information are also contemplated.

According to embodiments, the CXH API 318 may be configured (e.g., in connection with other components of the operating environment 300) to customize a user experience with the system at any number of various levels such as, for example, the organization level, the farm level, the field level, the crop level, and/or the like. According to embodiments, the operating environment 300 may be configured to create a digital representation of a grower's business, including characterizations of various grow operations, business needs, objectives, and/or the like. This representation may be used by the CXH API 318 and/or any other component of the operating environment to customize a user experience such that the grower's interactions with the operating environment are integrated with the grower's internal business practice and structure.

That is, for example, the CXH API 318 may be configured to utilize and assimilate information stored in the grower database at these various levels to provide a relevant customized user experience. At the organization level, the CXH API 318 may be configured to provide content relevant to a user (e.g., grower), who may have a number of different grow operations. In this manner, for example, an experience may be provided to the grower that incorporates information associated with locations corresponding to the different grow operations, differences between the different grow operations, considerations corresponding to allocation of resources between the different grow operations, and/or the like.

For example, in embodiments, a grower may have a year-round lettuce farm in Arizona, a wheat farm in Kansas, and a corn farm in Iowa. At an organization level, then, the operating CXH API 318 may be configured to provide and organize content that enables the grower to, at a glance, is relevant and contextual. For example, during the winter, when the farms in Kansas and Iowa are not actively growing crops, information pertaining to the farm in Arizona may be presented as the most prominent information. During the spring and summer, information related to the farms in Kansas and Iowa may be presented as prominently as (or more prominently than) information associated with the farm in Arizona. Additionally, in embodiments, for example, during or near the start of tax season, a selectable link for accessing invoices and/or other documents relevant for taxes may be prominently displayed. In embodiments, reminders associated with differences in tax laws among the different states in which an organization operates may be prominently presented. Any number of other types of information may be presented that may be particularly relevant to an organization at the organization level such as, for example, large regional/national weather maps, market comparisons and/or predictions among several geographic locations and/or types of crop; and/or the like. For example, embodiments facilitate field-by-field, and whole farm crop plans that can be shared among crop consultants and growers. At the organization level, embodiments may be configured to provide lender/insurance ready crop planning outputs that can be used by growers to facilitate obtaining loans, reporting on existing loans, reporting to shareholders, and/or the like.

According to embodiments, the CXH API 318 (and/or any other component of the operating environment 300) may be configured to facilitate storing information and/or accessing information in a manner in which accessing the information later can be done more efficiently. For example, in embodiments, there may be product inventory and/or suggestions relevant to a grow operation in Arizona that aren't relevant to a grow operation in Kansas or Iowa and, as such, embodiments of the operating environment may be configured to associate that product information/suggestions with the organization's grow operation in Arizona, but not the grow operations in Kansas or Iowa. For example, relational databases may be used to key such information to the grow operation in Arizona such that, when the CXH 318 (and/or other component) is facilitating a user experience associated with the Arizona grow operation, the system need only access that associated information, which may facilitate more efficient customization and presenting of the user experience. This may be an example of using farm level data to enhance an organization level experience. Similar efficiencies may be achieved by associating uniquely relevant information at the farm level, the field level, and/or the crop level.

The experiences APIs may further include a crop planning API 320 configured to facilitate providing crop planning services (and/or aspects thereof) to the access component 302. For example, in embodiments, the crop planning API 320 may be configured to provide agronomy endpoints that provide create, read, update, and delete (CRUD) access to collections of related agronomy models such as accounts that have farms, farms that have fields, fields that have crop plans, and/or the like. In embodiments, the crop planning API 320 may be configured to drive a user experience in the CXH and/or the EXH. Embodiments of the crop planning experience may include semi-automated workflows and predictive capabilities (e.g., next crop in rotation, target yields, planting events, etc.) that may be used to simplify a crop planning process such as, for example, by automatically generating a suggested crop plan that can be modified in accordance with user input. In embodiments, a crop planning service may include seed advisory services, nutrient advisory services, and/or the like. In this manner, analytical and predictive algorithms may be utilized to automatically generate aspects of a crop plan, including specific product recommendations, service recommendations, and/or the like, based at least in part on grower data such as characteristics and goals (e.g., desired/historical yield, profit, risk, sustainability, etc.). The output may include a crop plan that includes selectable links configured to facilitate grower access to a retail interface from which the grower can order specifically suggested products (e.g., seeds, fertilizers, pesticides) and/or services (e.g., product application, soil sampling, etc.).

According to embodiments, the crop planning API 320 may be programmed to facilitate a crop planning service by interacting with any number of other APIs and providing a crop planning interface that may include, for example, a number of fillable fields, interactive elements, drop-down menus, selectable options, and/or the like. In embodiments, the crop planning API 320 may be configured to surface predictive information from other aspects of the system such as, for example, from the Insights API 330. That is, for example, a crop planning interface provided by the crop planning API 320 may include some input fields that are pre-populated with known and/or predicted information. For example, upon instantiating a crop-planning interface (e.g., in response to receiving a grower selection of a selectable representation of a crop planning service provided as a suggestion), the crop planning API 320 may, in conjunction with the insight API 330 and/or any number of other system components, access grower data associated with the grower and may, based on the grower data, fill in one or more input fields of the crop planning interface. For example, the insight API 330 may predict, based on historical grower data, a desired yield, type of crop to be planted, seed type, a desired profit range, a planting date and/or range of dates, and/or the like. In embodiments, the crop planning interface fields may be auto-filled based on one or more stored crop-planning models, which may include, for example, historical data (and/or aggregates or derivations thereof) such as, for example, soil types, soil compositions, crop seeds planted, crop yields, disease trends, pest trends, and/or the like. Additionally, in embodiments, predicted information may be used to facilitate auto-filling the crop plan such as, for example, weather predictions, disease activity predictions, pest event predictions, and/or the like. In yet other embodiments, predictive information of these types can be generated based on computational agronomic simulations that do not use historical grower data as an input. In this manner, embodiments of the operating environment 300 may facilitate providing an interactive, predictive, and assistive interface that may facilitate ease of use by growers.

An Ecommerce API 322 may be configured to provide data access for various operations such as CRUD operations for facilitating commerce activities via one or more of the aspects of the access component 302. For example, in embodiments, the Ecommerce API 322 may be configured to facilitate providing product and pricing information, managing a shopping cart, receiving orders through an online shopping experience (e.g., via the CXH 312), and/or the like. In embodiments, the Ecommerce API 322 may be configured to facilitate commercial transactions by providing a transaction pipeline to an underlying transactional system within the business systems 345. According to embodiments, the Ecommerce API 322 may be configured to work in conjunction with any number of other operating environment components to provide suggestions such as, for example, suggestions of similar products to those being purchased and/or viewed by a grower, complimentary products to those being purchased and/or viewed by a grower, and/or the like.

An EXH API 324 may be configured to facilitate interactions between the EXH 314 and backend business systems 345, e.g., by providing an interface between the EXH 314 and the core services APIs 328. In embodiments, the EXH API 324 may facilitate providing data for displaying customer account information, invoice and purchase history, market information, and/or the like, tailored for display in the EXH 314.

A BXH API 326 may be configured to facilitate interactions between the BXH 316 and backend business systems 345, e.g., by providing an interface between the BXH 316 and the set 328 of core services APIs. In embodiments, the BXH API 326 may be configured to provide data endpoints that provide CRUD access for external systems (e.g., systems associated with customers, suppliers, etc.) to internal systems of record and transactional systems. According to embodiments, third party integrators may include, for example, seed distributors, nutrient blenders/applicators, larger growers (e.g., industrial size farming operation managers), and/or the like.

The service component 304 may also include a data lake 342. According to embodiments, the data lake 342 may include any number of different types of data processing and/or storage components configured to serve as a data clearinghouse. That is, for example, in embodiments, the data lake 342 may include components configured to obtain data from any number of various sources, components configured to normalize data, components configured to clean, transform, and/or calculate data, components configured to maintain storage of data, components configured to restrict access to certain types of data, and/or the like. In this manner, the service component 304 may be configured to consume and use any number of different types of data, providing information-based functionality to the various other components thereof. For example, the data lake 342 may serve as a data hub for internal and external data sources including grower, farm, field, product, soil sample, and purchase data that enables exploratory and advanced data analysis to quickly gain actionable insights, which may be used to provide contextually-relevant and customized user experiences.

As shown, the set 328 of core services APIs may include an insight API 330 that may be configured to utilize science to provide searchable data models, predictive information, notifications, and/or the like. For example, in embodiments, the insight API 330 may be configured to facilitate providing an interface to search and retrieve model results for a wide range of requests including cross-sell and upsell opportunities and complimentary product suggestions. The insight API 330 may include any number of different components such as, for example, an analytics component 346 configured to perform analytics on any number of different types of data; a forecast component 348 configured to provide predictive services regarding weather, market activity, crop performance, and/or the like; a trends component 350 configured to determine and provide representations of various data trends; a recommendations component 352 configured to provide product and/or operations recommendations, and/or the like.

According to embodiments, any one or more aspects of the insight API 330 may be configured to use various algorithms and mathematical modeling such as, for example, trend and statistical analysis, data mining, pattern recognition, cluster analysis, neural networks and fuzzy logic. For example, the insight API 330 may perform deterministic and probabilistic calculations. Deterministic calculations include algorithms for which a clear correlation is known between the data analyzed and a given outcome. In embodiments, the insight API 330 may include machine-learning capabilities.

According to embodiments, for example, the insight API 330 may be configured to facilitate a weather alert service by aggregating weather information from multiple sources, generating weather forecasts corresponding to specific geographic locations (or receiving weather forecasts from other sources), predicting agronomic consequences based on the weather predictions and associated grower data. In embodiments, the insight API 330 may be configured to provide forecasts related to temperatures, precipitation, growing degree days (GDD), and/or the like. In embodiments, the forecasts may be generated by the forecast 348 component, which may be implemented using any number of different types of predictive algorithms. The forecasts may be used, for example, by the recommendations component 352 to generate recommendations such as, for example, nutrient blends to use, days and times for applying products to a field, flow rates for product application, and/or the like. In this manner, embodiments of the subject matter disclosed herein may be used to drive frequency and depth of grower engagement with weather data.

According to embodiments, for example, the insight API 330 may be configured to facilitate providing a dynamic user experience configured to mitigate the impact of certain weather events on certain grow operations. For example, weather events that involve precipitation may cause nitrogen to be leached out of the soil, resulting in a nitrogen deficiency, which may have an adverse effect on one or more crops growing in the effected field. Embodiments of the operating environment may be configured to mitigate the risk of damage to the grow operation by facilitating a predictive user experience.

In embodiments, for example, the forecast component 348 may be configured to generate or obtain weather information such as forecasts for any number of different regions. In embodiments, the forecast component 348 may be configured, for example, to generate or obtain weather information in response to user requests, in response to receiving a notification of an upcoming weather event, in response to a pre-set trigger (e.g., at certain times of the day, in response to the occurrence of certain events, etc.), and/or the like. In embodiments, the forecast component 348 may be configured for use in connection with any region corresponding to a grow operation that is registered with the operating environment 300.

The insight API 330 (e.g., using the analytics component 346, the forecast component 348, and/or the like) may be configured to predict, for a particular field, or portion thereof, an amount of runoff or erosion that may be caused by a particular weather event. The amount of runoff may refer to an amount of water that is expected to run off of the field, an amount of a certain nutrient that is expected to be carried off the field by water running off the field, and/or the like. In embodiments, the insight API 330 can predict, based on the determined runoff and field characteristics (which may be obtained, e.g., via a database, the agronomy API 334, and/or the like), a predicted nutrient deficiency (e.g., nitrogen deficiency) for the field, or part thereof.

The Insight API 330 may be configured to facilitate providing a notification, upon predicting the nutrient deficiency, to the grower, a crop consultant, another functional component, and/or the like. For example, in embodiments, the Insight API 330 may provide a notification to the grower via the CXH API 318, to a crop consultant via the EXH API 324, and/or the like. In embodiments, the recommendations module 352 of the Insight API 330 may be configured to generate one or more recommendations for taking action to mitigate the effect of the weather event, based on the predicted nutrient deficiency. For example, in embodiments, the recommendations module 352 may be configured to generate a prescription for applying nitrogen to the field or portion thereof after the weather event.

In embodiments, the user may be made aware of options for mitigating and/or otherwise preparing for the predicted crop growth conditions. For example, the Insight API 330 may provide a notification to the ecommerce API 332 that indicates the recommended nutrient treatment. In response to receiving the notification, the ecommerce API 332 may check inventory 360 to determine whether there is inventory available that corresponds to the recommendation. The ecommerce API 332 may additionally, or alternatively, be configured to provide a selectable link, via the CXH API 318, the Ecommerce API 322, and/or the EXH API 324, to a purchase interface, from which the grower can order the recommended nutrient and/or an application service for applying the recommended nutrient. In embodiments, the ecommerce API 332 may be configured to automatically order, in response to receiving the notification, the recommended nutrient, and/or an application service for applying the recommended nutrient. According to embodiments, any number of other types of predictive mitigation services may be facilitated using the Insight API 330 such as mitigation services corresponding to predicted natural disasters, market events, and/or the like.

As shown, the set 328 of core services APIs may further include an Ecommerce API 332 configured to facilitate interactions between the CXH 312 and/or the EXH 314 and backend business systems 345 to facilitate enabling a customer to purchase products and/or services, to enable a consultant to access product and/or pricing data, to enable users and/or consultants to engage in service relationships, and/or the like. For example, in embodiments, the Ecommerce API 334 may be configured to provide and/or support CRUD operations for product and pricing data. In embodiments, the Ecommerce API 334 may be further configured to provide endpoints for submitting orders to internal transactional systems. The Ecommerce API 332 may include any number of different components such as, for example, a customer component 354 configured to facilitate customer interactions; a product component 356 configured to facilitate access to product recommendations, pricing, and/or the like; an orders component 358 configured to facilitate generation, manipulation, storage, retrieval, and management of product orders; an inventory component 360 configured to provide access to up-to-date inventory information; and/or the like.

An agronomy API 334 may be configured to facilitate interactions between the CXH 312 and/or the EXH 314 and backend business systems 344. In embodiments, the agronomy API 334 may be configured to provide and/or support CRUD operations for models related to crop planning such as farms, fields, programs, field plans, crops, scenarios and miscellaneous supporting models such as units. According to embodiments, the agronomy API 336 may be configured to communicate with the insight API 330 to obtain forecast information, analytics, recommendations, and/or the like, which may be used to support agronomic services such as, for example, recommending, generating, and managing crop plans.

As shown, the agronomy API 334 may include any number of different components such as, for example, a farm component 362 configured to facilitate providing agronomic services at the farm level (e.g., overall crop plans and utilization recommendations for the various aspects of a particular farm); a field component 364 configured to facilitate providing agronomic services at the field level (e.g., crop plans and utilization recommendations for a particular field); a crop component 366 configured to facilitate providing agronomic services at the crop level; a yield component 368 configured to facilitate providing specific types of yield analysis and alternative yield scenarios; and/or the like. In embodiments, for example, the field component 364 may be configured to create, maintain, and/or otherwise access geospatial field maps of fields. The field maps may be, for example, used to enable any number of field-level services. For example, historical data and future predictions associated with certain fields and/or portions thereof may be associated with the field maps to assist with efficient access and editing thereof. According to embodiments, aspects of the operating environment may be configured to provide the ability for users (growers, crop consultants, etc.) to manage information associated with a grower's farms and fields and to create, edit, upload, and view field boundaries. Additional and other types of information used by the system, including those described above, can be stored or accessed through one or more of components 362, 364, 366 and 368.

Additionally, in embodiments, the field maps may be used as an index for scientific analysis to facilitate predictive services. That is, for example, as explained elsewhere, constructs such as field “maps” may be used to associate soil samples with the geographic locations from which they were collected. According to embodiments, historical information about a grow operation such as, for example, types of crops planted, yields realized, products applied, impacts from historical weather events, pest activity, soil quality, air quality, and/or the like may all be stored in a database for any amount of time and may, in embodiments, be associated with field maps. In this manner, such historical information can be geographically relevant, facilitating predictive services that can leverage agronomic modeling and highly granular agronomic data in predicting future characteristics and/or events, recommending products, and/or the like.

According to embodiments, for example, the agronomy API 334 may be used to facilitate a nutrient advisor service configured to provide dynamic recommendations regarding nutrient management at the crop level, field level, farm level, and/or the like. According to embodiments, a nutrient advisor service may utilize the insight API 330 as well, such as, for example, to utilize various types of analytics including, for example, analysis of soil samples, to facilitate automated generation of nutrient prescriptions for a grower's field. The agronomy API 334 may interact with the notify API 336, the crop planning API 320, and/or the CXH API 318 to automatically present generated prescriptions to a grower. According to embodiments, the nutrient advisor service may be automatically initiated based on a trigger event such as, for example, a weather event, an agronomic prediction, an identified agronomic condition, a disease event, a disease event prediction, a pest event, a pest event prediction, and/or the like. In embodiments, recommendations generated as part of the nutrient advisor service may be pushed to users (e.g., growers to whom the information may be relevant, crop consultants associated with growers to whom the information may be relevant, etc.).

According to embodiments, for example, a nutrient advisor service may utilize geospatial field maps via the field component 364 to facilitate nutrient mapping, prescription generation, and/or the like. For example, in embodiments, soil samples may be obtained for a field at different locations within the field, and the soil samples may be automatically associated with locations represented on a corresponding field map. For example, the field component 364 may be configured to automatically generate a sampling grid corresponding to the field map, and soil sample data may be automatically associated with corresponding locations on the sampling grid. In this manner, a nutrient advisor service may be configured to provide prescriptions based on current and/or historical sample data at the field level. The prescriptions may be presented to a grower via the grower's interface using selectable representations that can be selected by the grower to facilitate ordering the prescription service. Ordering a prescription service may include ordering a product, scheduling an application, and/or the like. According to embodiments, the agronomy API 334 may work with the insight API 330 to leverage historical samples, such as, for example, to generate variable prescriptions using predictive nutrient modeling, fixed rate prescriptions using nutrient modeling, and/or the like. In embodiments, prescriptions may use grid-based samples, zone-based samples, whole field samples, composite samples, and/or the like.

According to embodiments, the agronomy API 334 (e.g., in connection with the crop planning API 320) may be configured to provide any number of other crop planning services. For example, fields may be monitored for nitrogen deficiency, resulting in notifications being provided to growers and consultants. In embodiments, seed advisory services may be provided to facilitate selection and planning of seed planting at the farm level, field level, and/or crop level. Pest and disease management may be facilitated by the agronomy API 334, in embodiments. For example, the agronomy API 334 may work in connection with the insight API 330 to generate pest and/or disease models that may be used to proactively facilitate product and/or service recommendations. In embodiments, the agronomy API 334 may utilize grower data (e.g., data associated with yield, profit, risk, sustainability, etc.) to facilitate automated generation of crop plans. In embodiments, crop plans may be pre-populated using predictive capabilities (e.g., via the insight API 330) that may be used to predict next crop in rotation, planting events, and/or the like. According to embodiments, such grower data, predicted information, and/or predictive algorithms may be maintained as stored models, and may correspond to certain growers, geographic locations, crop types, and/or the like.

The set 328 of core services APIs may also include, for example, a notifications API 336 that may be configured to provide a pipeline for sending notifications between systems in a variety of formats including email, SMS, system messages, and/or the like. Notifications may include, for example, new statements, invoices, indications of payments received, order statements, automatic suggestions (e.g., prescriptions, weather impact mitigations, etc.), and/or the like. An authentication API 338 may be configured to authenticate username and password combinations for customers and internal employees. In embodiments, for example, the authentication API 328 may be further configured to issue identity tokens.

An account API 340 may be configured to maintain and/or provide customer account information including invoices, statements, purchase history and account balances. In embodiments, the account API 332 may further be configured to provide endpoints for submitting payments. Embodiments of the account API 340 may be configured to facilitate creating and managing user accounts. For example, the API 340 may be configured to facilitate developing profiles associated with users. In embodiments, the account API 340 may create a user profile associated with a user and may store user data received from any of the various components of the operating environment 300 in the user profile (e.g., by associating the data with the user profile).

In embodiments, if demographic information and/or other user data such as, for example, the user's name, is not known, the account API 340 may create a user profile that is identified by a first identifier (e.g., an internet protocol (IP) address, a media access control (MAC) address, a random or pseudo-random generated identifier, an assigned user identifier, etc.) associated with the profile and, when the user name or other user-specific demographic information is known, the account API 340 may substitute a second identifier (e.g., the user's name, a hash of the user's name, etc.) for the first identifier. In this manner, embodiments of the operating environment 300 may be configured to provide contextually-relevant, customized content to the user as early as possible.

According to embodiments, the integration sources 310 may include any number of third-party services that may be integrated with the services provided by the service component 304. For example, in embodiments, the integration sources 310 may include partner integrations, third-party pass through services, public resources, and/or the like. In embodiments, the integration sources 310 may include specific functionalities that may be utilized, for example, by the insight API 330 to provide predictive services, recommendations, and/or the like. For example, in embodiments, an integration source 310 may include a fertilizer prescription tool such as the fertilizer prescription tool described in PCT publication WO 2017/147682.

The illustrative operating environment 300 shown in FIG. 3 is not intended to suggest any limitation as to the scope of use or functionality of embodiments of the present disclosure. The illustrative operating environment 300 also should not be interpreted as having any dependency or requirement related to any single component or combination of components illustrated therein. Additionally, various components depicted in FIG. 3 may be, in embodiments, integrated with various ones of the other components depicted therein (and/or components not illustrated), all of which are considered to be within the ambit of the present disclosure.

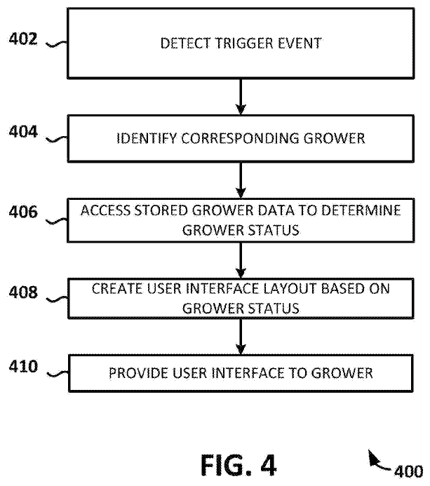

User Experience Scenarios FIG. 4 is a flow diagram depicting a method 400 of facilitating agriculture management by providing an experience to a grower that is dynamic, consistent, and that persists throughout the year, during both the growing season and the time in between growing seasons. According to embodiments, the method 400 may be performed by, or using, a system such as the illustrative system 100 depicted in FIG. 1, the management platform 102 depicted in FIG. 1, and/or any number of aspects of the operating environment 300 depicted in FIG. 3.

According to embodiments, the method 400 includes detecting a trigger event (block 402), and identifying a corresponding grower (block 404). According to embodiments, detection of the trigger event and identification of the grower may occur simultaneously or in reverse order, such as, for example, where a trigger event is detected with respect to a particular grower. In embodiments, trigger events may include any number of different types of events that change some circumstance that may provide an opportunity for the system to anticipate needs of a grower. For example, a trigger event may include a login event, where the login event results in a logged in grower interacting with the system. Trigger events may include events identified based on inputted parameters such as, for example, weather information, pest activity, imagery, disease information, and/or the like. Similarly, detecting a trigger event may include predicting the trigger event (e.g., based on a weather forecast, historical trend, market forecast, etc.) and/or determining the trigger event from knowledge (e.g., disease detected by grower representatives in neighboring fields or reported by government farm bureaus).

According to embodiments, the method may include accessing stored grower data associated with the corresponding grower to determine a grower status of the grower (block 406). According to embodiments, a grower status refers to a level of engagement with the system. Put another way, a grower status may refer to functionality, products, services, and/or the like that have not yet been provided to the grower or that the grower has not yet taken advantage of—e.g., opportunities for further engaging with the grower and building a relationship with the grower. That is, for example, a grower status may include an indication that indicates that the grower has received some products and/or services but not others. In this manner, the grower status may be used to customize aspects of a user interface experience for the grower, identify appropriate products and/or services to market to the grower, and/or the like.

The method 400 may further include creating a user interface having a layout that is designed based on the grower status (block 408); and providing the user interface to the grower (block 410). As an example, a grower status may include an indication that indicates that the grower has received a first product and/or service, and/or an indication that indicates that the grower has not received a second product and/or service. For example, the grower may have received a crop plan (e.g., a first product) but is not signed up to receive a weather alert service. In such a case, the method 400 may further include creating a user interface having a layout that is designed to provide relevant information to the grower based on the grower status. For example, the user interface may include a notification of an available weather alert service, the notification comprising a selectable link configured to be selected by the grower to facilitate ordering the weather alert service.

In another example, for example, an insight API (e.g., the Insight API 330 depicted in FIG. 3) may identify an upcoming weather event based on a weather forecast such as a precipitation event. The insight API may further predict an amount of runoff due to the precipitation event that would likely result in a nitrogen deficiency in fields located in a certain region. The insight API (or another component of the system) may, in response, identify from a database, a number of growers that have grow operations in that region. For each grower with a grow operation in that region, the insight API (e.g., an analytics component thereof such as, for example, the analytics component 346) may retrieve historical and/or current information about the field located in that region and perform an analysis to determine an amount of runoff likely to occur and may for each field, or a portion thereof, predict a level of nitrogen deficiency likely to occur as a result. A recommendation module (e.g., the recommendation component 352 depicted in FIG. 3) may generate a recommendation of an amount of nitrogen to add to the field or portion thereof, and that recommendation may include a date and time that is recommended for applying the nitrogen. In embodiments, the recommendation component may be configured to generate blending instructions and provide them to a product blender, and/or application instructions, which may be provided to an application device.

According to embodiments, the insight API may provide a notification to a CXH API (e.g., the CXH API 318 depicted in FIG. 3), which may, in response, customize a user interface accordingly. For example, in embodiments, the CXH API may cause an interface provided to the grower to include a visible warning regarding the identified weather event and may include, for example, a selectable link that is configured to present an order interface upon being selected by the grower. From the order interface, in embodiments, the grower may be able to order the recommended nitrogen and/or application services by simply selecting a selectable user interface element. Any number of other methods of customizing a user interface to facilitate enabling the grower to take steps to mitigate the predicted effect of the predicted weather event may be utilized.

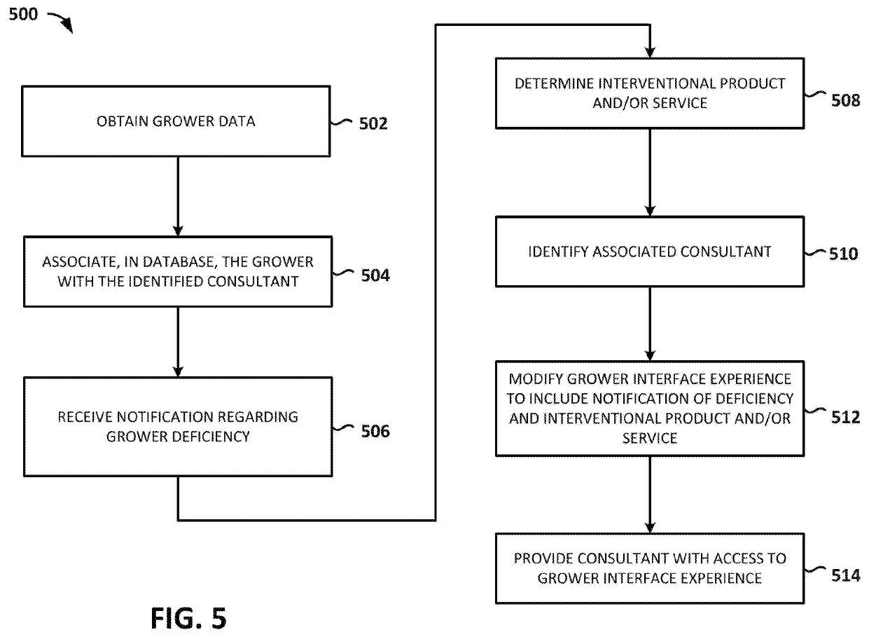

FIG. 5 is a flow diagram depicting another illustrative method 500 of facilitating agriculture management. According to embodiments, the method 500 may be performed by, or using, a system such as the illustrative system 100 depicted in FIG. 1, the management platform 102 depicted in FIG. 1, and/or any number of aspects of the operating environment 300 depicted in FIG. 3. Embodiments of the method 500 are configured to facilitate anticipating needs of a grower by identifying or predicting a deficiency and by automatically suggesting and/or providing one or more products configured to facilitate mitigating the deficiency. In embodiments, the method 500 is designed to anticipate these situations, often before the grower thinks of it, and is configured to make it easy for the grower to move forward with mitigating actions.

Embodiments of the method 500 include obtaining grower data associated with a grower (block 502). According to embodiments, the grower data may include any number of different types of information such as, for example, organization level data (e.g., business information, demographic information associated with the grower, etc.), farm level data (e.g., geographic locations of farms, types of farms, financial information associated with each farm, etc.), field level data (e.g., geographic boundaries of fields, historical data associated with seeds and/or inputs applied to the fields or portions thereof, soil sample information associated with fields or portions thereof, etc.), and/or the like. The grower data may be provided by the grower and/or obtained from other sources of information, and may be stored in a database, which may, as explained herein, be organized, at least in part, by organization level data, farm level data, field level data, crop level data, and/or the like.

As shown in FIG. 5, embodiments of the method 500 may include associating, in a consultant database, the grower with an identified consultant (block 504). identifying, based on the grower data, an appropriate consultant from a list of consultants maintained in a consultant database According to embodiments, for example, consultants may be selected based on proximity to the geographic location of the field, expertise with certain types of crops and/or grow operations, and/or the like. That is, for example, embodiments of the method 500 may include manual identification of an appropriate consultant, random identification of an appropriate consultant, and/or the like.

In embodiments, the method 500 may further include receiving a notification regarding a grower deficiency, the grower deficiency comprising an aspect of a grow operation that could benefit from intervention (block 506); and determining an interventional product and/or service associated with the grower deficiency (block 508). According to embodiments, the grower deficiency may include any condition, situation, or state of an aspect of a grow operation that could be improved by taking an action such as applying a product. For example, a grower deficiency may include an inadequate nitrogen level, a predicted weather event, a predicted need for an increase in nutrient applications, and/or the like. According to embodiments, the interventional product and/or service may include a crop planning service, a nutrient product, and/or the like. In embodiments, the grower deficiency may be an identified condition of the field based on analysis of a soil sample and the interventional product may be a post sample package including, for example, an order for a nutrient product, instructions for its application, and/or the like.

For example, in embodiments, an insight API (e.g., the Insight API 330 depicted in FIG. 3) may be configured to perform analytics associated with a grower's field, or portion thereof (e.g., as represented in a field map), based on predicted events, historical information, and/or the like. For example, the insight API may identify a recurring pest or disease event trend throughout history in a particular region and may predict that a recurrence of that type of event is likely to take place within a certain amount of time in the near future. Additionally, or alternatively, a pest or disease event may be identified from other sources such as regional agronomy reports, inputs from crop consultants, and/or the like. A recommendation module may predict that application of a particular pesticide, fungicide, and/or the like, at a particular time and application rate would be likely to prevent and/or mitigate the recurrence of that event.

As shown in FIG. 5, the method 500 may further include identifying, by accessing the consultant database, the associated consultant (block 510); modifying a grower interface experience to include a notification regarding the grower deficiency and the identified interventional product and/or service (block 514); and providing the consultant with access to the grower interface experience (block 516). That is, in the context of the example above, a CXH API (e.g., the CXH API 318 depicted in FIG. 3) may be configured to include a visible warning and/or selectable link on a user interface for the grower, and to provide that same visible modification, via an EXH API (e.g., the EXH API 324 depicted in FIG. 3) to a corresponding crop consultant. In this manner, the crop consultant can see the information that the grower sees, thus facilitating more efficient conversations between the two.

For example, in embodiments, the Insight API may determine, based on imagery and/or soil sample data, that a grower's field is not being fertilized enough to result in a desired crop yield. Upon making this determination, the Insight API may provide a notification to a CXH API, which may be configured to interact with an Ecommerce API (e.g., the Ecommerce API 322 depicted in FIG. 3) to provide a selectable link on a user experience that, upon being selected by the grower, results in an order screen, product information screen, and/or the like being presented to the grower. In embodiments, a recommendation component (e.g., the recommendations component 352 depicted in FIG. 3) may determine that one or more fertilizer blends could be used to mitigate the identified deficiency. A crop consultant may also be made aware of the deficiency and the recommended products so that the crop consultant may reach out to the grower to offer advice on which of the recommended products may be best for the grower's particular operation, and/or the like.

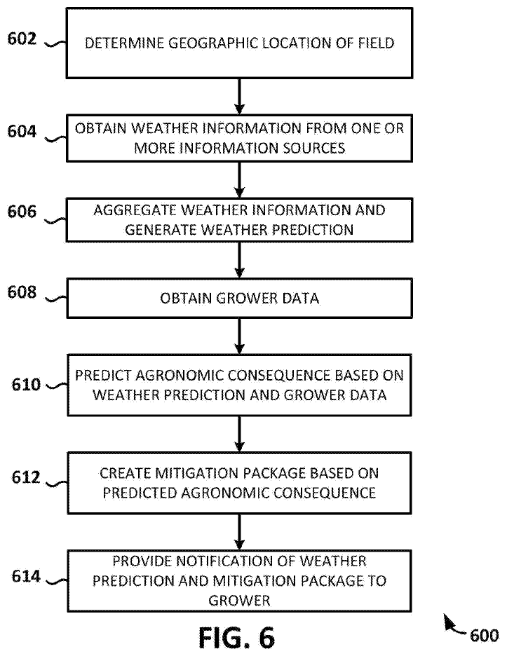

FIG. 6 is a flow diagram depicting another illustrative method 600 of providing year-round agriculture management services, utilizing a system. According to embodiments, the method 400 may be performed by or using, a system such as the illustrative system 100 depicted in FIG. 1, the management platform 102 depicted in FIG. 1, and/or any number of aspects of the operating environment 300 depicted in FIG. 3. Embodiments of the method 600 include determining a geographic location of a field associated with a grower (block 602), and obtaining weather or other information corresponding to the geographic location from one or more information sources (block 604). Some embodiments optionally include generating, based on aggregated weather data, a weather prediction corresponding to the geographic location (block 606).

In embodiments, the method 600 further includes obtaining grower data associated with the grower (block 608). In embodiments, for example, the grower data may include agronomic information such as at least one of a type of crop planted in at least one field associated with the grower and a characteristic of soil of at least one field associated with the grower. Embodiments of the method 600 include predicting an agronomic consequence based on the weather information and the grower data (block 610); and creating a mitigation package based on the predicted weather consequence (block 612). In embodiments, creating the mitigation package may include determining an amount of a nutrient to be added to the at least one field associated with the grower, and creating a package including an order for that amount of that nutrient.

In embodiments, the method 600 may include providing a notification of the mitigation package, and optionally the weather event to the grower (block 614). According to embodiments, wherein the notification comprises a selectable representation configured to cause the system to provide an order interface in response to user selection of the selectable representation, wherein the order interface facilitates at least one of ordering the nutrient and scheduling its application

According to embodiments, for example, the method 600 may be used to anticipate and mitigate a nitrogen deficiency, as explained above, with respect to the insight API 330 depicted in FIG. 3. Aspects of a method similar to the method 600 may be used to predict and mitigate the effects of circumstances other than weather. For example, similar methods may be used to predict, based on other agronomic information, and/or other information such as average temperatures, amounts of precipitation, barometric pressure, human activity in the area and/or the like, pest activity, disease activity, market activity, and/or the like. Based on analysis of trends, current circumstances, and/or the like, for example, a recurrence of an infestation of crop-eating beetles may be predicted and a preventative pesticide recommended for mitigation of the predicted infestation.

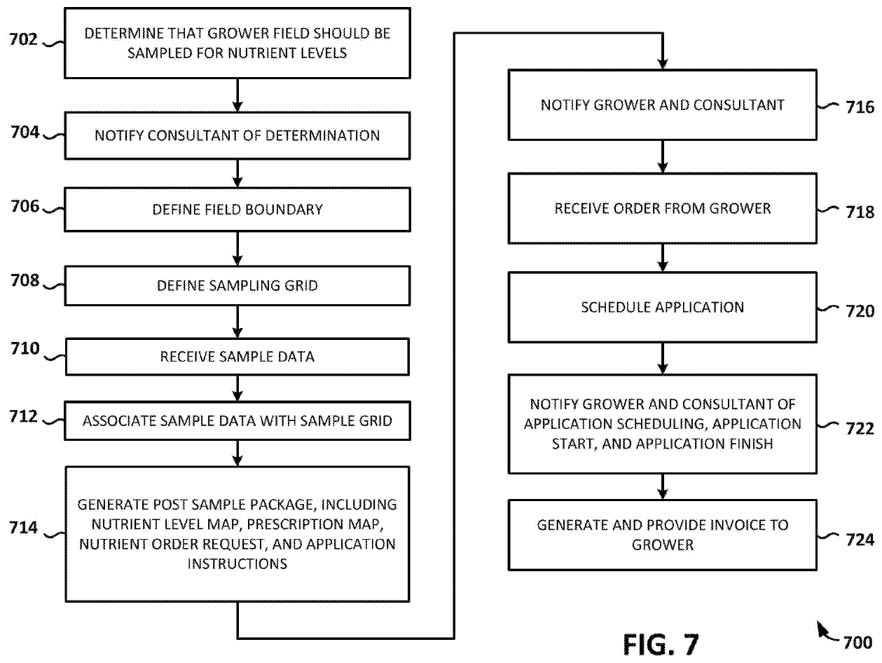

FIG. 7 is a flow diagram depicting another illustrative method 700 of providing year-round agriculture management services to a grower, in accordance with embodiments of the subject matter described herein. According to embodiments, the method 700 may be performed by, or using, a system such as the illustrative system 100 depicted in FIG. 1, the management platform 102 depicted in FIG. 1, and/or any number of aspects of the operating environment 300 depicted in FIG. 3. According to embodiments, the method 700 may include determining that a grower's field should be sampled for nutrient levels (block 702); and notifying a consultant associated with the grower of the determination (block 704).

Embodiments of the method 700 include defining a field boundary corresponding to the grower's field (block 706); defining, based on the field boundary, a sampling grid (block 708); receiving sample data, the sample data comprising a plurality of data points, each data point including a sample location and at least one soil characteristic associated with the sample location (block 710); and associating, based on the sample location, the sample data with the sample grid (block 712). According to embodiments, the system may be configured to generate sample bags and/or kits that are printed with geospatial location labels, each label corresponding to a location on the sample grid. In this manner, more accurate and automatic logging of each sample may be facilitated. Any number of different types of analytics may be performed on soil samples, water samples, and/or the like, and may be associated with portions of fields based on the field maps generated thereof.

Sample data may be inputted into a database manually and/or automatically. Upon entering the sample data into the database, a sample data point may be associated with a location on a geographical field map corresponding to the field from which the soil sample was taken, and a historical record of sample data associated with each point may be generated over time, enabling analytics to be performed to assess soil characteristic trends. These analytics may be used in predictive modeling, determination of nutrient deficiency, and/or the like.

In embodiments, the method 700 may include generating a post sample package (block 714). For example, in embodiments, an analysis of the sample data, historical sample data, and/or any other information available about a field location may be used to determine that the location could be benefited by application of a certain product, such as is described in more detail above with regard to FIG. 3. The post sample package may include, for example, at least one of a nutrient level map, a prescription map, a request for an order of a nutrient product, a set of application instructions configured to cause an applicator to apply the nutrient product, and/or the like. Embodiments of the method 700 may further include notifying the grower and the consultant of the post sample package; receiving an order, corresponding to the post sample package, from the grower (block 718); and scheduling an application of the nutrient package (block 720). Additionally, embodiments may include notifying the grower and consultant of the application scheduling, the start of the application of the nutrient product, and the completion of the application of the nutrient product (block 722); and generating and providing an invoice to the grower corresponding to the application of the nutrient product (block 724).

Various modifications and additions can be made to the exemplary embodiments discussed without departing from the scope of the present disclosure. For example, while the embodiments described above refer to particular features, the scope of this disclosure also includes embodiments having different combinations of features and embodiments that do not include all of the described features. Accordingly, the scope of the present disclosure is intended to embrace all such alternatives, modifications, and variations as fall within the scope of the claims, together with all equivalents thereof.

1. A system configured to facilitate agriculture management, the system comprising:
a server device having a processor and a computer-readable memory having computer executable instructions embodied thereon, wherein the instructions are configured to cause the processor, upon being executed by the processor, to perform a method of facilitating a consistent user experience for agriculture management, the method comprising:
detecting a trigger event;
identifying a corresponding grower;
accessing stored grower data associated with the corresponding grower to determine a grower status of the corresponding grower;
creating a user interface having a layout that is designed based on the grower status; and
providing the user interface to the grower.

2. The method of claim 1, wherein the grower status comprises an indication that indicates that the grower has received a first product and/or service.

3. The method of claim 2, wherein the grower status comprises an indication that indicates that the grower has not received a second product and/or service.

4. A method of facilitating agriculture management, the method comprising:
detecting a trigger event;
identifying a corresponding grower;
accessing stored grower data associated with the corresponding grower to determine a grower status of the corresponding grower;
creating a user interface having a layout that is designed based on the grower status; and
providing the user interface to the grower.

5. The method of claim 4, wherein the grower status comprises an indication that indicates that the grower has received a first product and/or service.

6. The method of claim 5, wherein the grower status comprises an indication that indicates that the grower has not received a second product and/or service.

7. The method of claim 6, wherein the first product and/or service comprises a crop plan.

8. The method of claim 7, wherein the second product and/or service comprises a weather alert service.

9. The method of claim 8, wherein the user interface comprises a notification of an available weather alert service, the notification comprising a selectable link configured to be selected by the grower to facilitate ordering the weather alert service.

10. A method of facilitating agriculture management the method comprising:
obtaining grower data associated with a grower;
associating, in a consultant database, the grower with an identified consultant;
receiving a notification regarding a grower deficiency, the grower deficiency comprising an aspect of a grow operation that could benefit from intervention;
determining an interventional product and/or service associated with the grower deficiency;
identifying, by accessing the consultant database, the associated consultant;
modifying a grower interface experience to include a notification regarding the grower deficiency and the identified interventional product and, or service; and
providing the consultant with access to the grower interface experience.

11. The method of claim 10, wherein the interventional product and/or service comprises a crop planning service.

12. The method of claim 10, wherein the interventional product and/or service comprises a post sample package.

13. The method of claim 10, wherein the interventional product and/or service comprises a post sample package.

14. The method of claim 10, wherein the interventional product and/or service comprises a nutrient product.

15. A method of providing agriculture management services, utilizing a system, the method comprising:
determining a geographic location of a field associated with a grower;
obtaining weather information, optionally a weather forecast, corresponding to the geographic location from one or mote information sources;
obtaining grower data associated with the grower;
predicting an agronomic consequence based on the weather information and the grower data;
creating a mitigation package based on the agronomic consequence; and
providing a notification of the mitigation package and optionally the weather consequence to the grower.

16. The method of claim 15, the grower data comprising at least one of a type of crop planted in at least one field associated with the grower, and a characteristic of soil of at least one field associated with the grower.

17. The method of claim 16, wherein creating the mitigation package comprises determining an amount of a nutrient to be added to the at least one field associated with the grower.

18. The method of claim 15, wherein the notification comprises a selectable representation configured to cause the system to provide an order interface in response to user selection of the selectable representation, wherein the order interface facilitates at least one of ordering the nutrient and scheduling its application.

19. A method, comprising:
determining that a grower's field should be sampled for nutrient levels;
notifying a consultant associated with the grower of the determination,
defining a field boundary corresponding to the grower's field;
defining, based on the field boundary, a sampling grid;
receiving sample data, the sample data comprising a plurality of data points, each data point including a sample location and at least one soil characteristic associated with the sample location;
associating, based on the sample location, the sample data with the sample grid;
generating a post sample package;
notifying the grower and the consultant of the post sample package, the post sample package comprising a request for an order of a nutrient product;
receiving an order, corresponding to the post sample package, from the grower;
scheduling an application of the nutrient package;
notifying the grower and consultant of the application scheduling, the start of the application of the nutrient product, and the completion of the application of the nutrient product; and
generating and providing an invoice to the power corresponding to the application of the nutrient product.

20. The method of claim 20, the post sample package further comprising at least one of a nutrient level map, a prescription map, and a set of application instructions configured to cause an applicator to apply the nutrient product.

21. A method of providing agriculture management services, utilizing a system, the method comprising:
determining a geographic location of a field associated with a grower;
obtaining information representative of an event prediction corresponding to the geographic location;
obtaining grower data associated with the grower;
predicting an agronomic consequence based on the event prediction and the grower data; and
providing a notification of the agronomic consequence to the grower.

22. The method of claim 21, obtaining information representative of an event prediction includes obtaining information representative of a weather forecast, a disease forecast, or a pest, forecast.

23. The method of claim 21, the grower data comprising at least one of a type of crop planted in at least one field associated with the grower, and a characteristic of soil of at least one field associated with the grower.

24. The method of claim 21, farther comprising creating a mitigation package based on the predicted agronomic consequence, wherein creating the mitigation package comprises determining an amount of a nutrient to be added to the at least one field associated with the grower.

25. The method of claim 24, wherein the notification comprises a selectable representation configured to cause the system to provide an order interface in response to user selection of the selectable representation, wherein the order interface facilitates at least one of ordering the nutrient and scheduling its application.
